(19) United States
(12) Patent Application Publication
(10) Pub. No.: US 2006/0047693 A1
(43) Pub. Date: Mar. 2, 2006

(54) Apparatus for and method of generating data extraction definition information

(76) Inventors: Gou Kojima, Yamato (JP); Tetsuo Tanaka, Yamato (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/153,475

(22) Filed: Jun. 16, 2005

(30) Foreign Application Priority Data
Aug. 25, 2004 (JP) 2004-245197

(51) Int. Cl. G06F 7/00; G06F 17/00

(52) U.S. Cl. 707/102

(57) ABSTRACT

In combining a plurality of user interfaces provided by servers into one user interface on a client, definition information used for extracting required information from the user interfaces as objects to be combined is generated efficiently. User interface information added with data extraction definition is prepared by inserting data items of the extraction destination into parts to be extracted in the information on the object user interfaces. Data extraction definition information, which defines extraction locations and the data items of the extraction destination and is used for extracting information from the user interface added with the data extraction definition, is generated based on the user interface information added with the data extraction definition

### BACKGROUND OF THE INVENTION

The present invention relates to a technique of generating data extraction definition information that is required for combining user interfaces so that data obtained from a plurality of information sources are presented combinedly to a user, and particularly to a technique suitable for client's use of a plurality of applications sent from servers to the client through a network or the like.

Some networks such as the Internet provide application services that use WWW (World Wide Web) as a user interface. When WWW is used, it is not necessary to prepare a dedicated client program for each application, and a WWW browser is sufficient for using every WWW-based application. However, there is no arrangement for using data in common among WWW-based applications, even when those applications each treat the common data. Therefore, for each application, a user must open a different window of the WWW browser and input the data.

To cope with this problem, Japanese Non-examined Patent Laid-Open No. 2003-345697 (U.S. application Ser. No. 10/373,047) discloses a system in which a user interface is provided as a combined page obtained by combining a plurality of WWW pages. In the following description, a unit of contents that is provided by a WWW server and can be seen at once on a WWW browser is referred to as a WWW page, and one WWW page that is newly generated by extracting desired contents from a plurality of WWW pages is referred to as a combined page.

In this system, WWW pages defined as objects to combine into a combined page are obtained respectively by accessing existing WWW servers that provide those WWW pages. The obtained pages are analyzed according to a previously defined procedure, to extract data in a structured data format. Then, the extracted data are used to generate the combined page according to a previously defined procedure for outputting a combined page. In generating a combined page, if there is a common data item among a plurality of object WWW pages, the output procedure may be defined such that the mentioned common data item is used as a key for obtaining a merged table and the merged table is outputted into the combined page.

According to this method, it is possible to use data in a plurality of WWW pages as data items that constitutes one combined page. For example, when a plurality of WWW pages constituting a combined page have respective tables and those tables have a common data item, then it is possible to provide a combined page that displays a table obtained by merging those tables. Further, since data in existing WWW pages can be used as data items in generating a combined page, it is possible to provide a combined page having a flexible layout free from the layouts of the existing WWW pages.

### SUMMARY OF THE INVENTION

Thus, when a user interface combining device is provided, a user can use a combined service that is combined from services provided by a plurality of WWW pages, only by accessing one combined page.

According to this system, for combining WWW pages, the object WWW pages are analyzed and information required for generating a combined page is extracted. The analysis processing and the extraction processing are automatically performed in accordance with definition information, which is referred to as data extraction definition information. Although the administrator of the system should generate the data extraction definition information, the format of the information is complex and it is difficult to define the information correctly.

The present invention has been made taking the above problem into consideration. An object of the present invention is to automatize analysis of object WWW pages and generation of data extraction definition information used for extracting required information, to enhance efficiency of generating the data extraction definition information and to reduce labors for generating the data extraction definition information.

To attain the above object, the data extraction definition information generation device according to the present invention generates data extraction definition information automatically in accordance with prescribed rules from a given page having a prescribed format.

In detail, the present invention provides a data extraction definition information generation device that provides data extraction definition information to a user interface combining device that provides a combined user interface to a client, with the combined user interface being generated, in accordance with the data extraction definition information, from a plurality of user interfaces provided by servers, comprising: a marked-up page generation means that generates a marked-up page by giving predetermined character strings (hereinafter, referred to as marks) for extracting data items required for constructing the combined user interface to the user interfaces provided by the servers; and a data extraction definition information generation means that analyzes the marked-up page generated by the marked-up page generation means and generates the data extraction definition information.

According to the present invention, it is possible to generate automatically data extraction definition information used for extracting information required for generating a combined page. And, as a result, it is possible to reduce labors for generating the data extraction definition information.

### BRIEF DESCRIPTION OF THE DRAWINGS

FIG. 1 is a block diagram showing a configuration of the whole system according to a first embodiment;

FIG. 2 shows an example of an HTML source of an existing WWW page as an object to be combined into a combined page according to the first embodiment;

FIG. 3 is a diagram showing data structure of data to be accumulated into extracted data according to the first embodiment;

FIG. 4 shows an example of data extraction definition information according to the first embodiment;

FIG. 5 is a diagram for explaining a functional configuration of a data extraction definition information generation device and for explaining processing of automatic generation of data extraction definition information according to the first embodiment;

FIG. 6 shows an example of a marked-up page according to the first embodiment;

FIG. 7 is a flowchart showing a flow of generation of data extraction definition information from a marked-up page according to the first embodiment;

FIG. 8 shows an example of an automatically-generated marked-up page according to a second embodiment;

FIG. 9 is a flowchart showing a flow of automatic generation of a marked-up page according to the second embodiment;

FIG. 10 is a diagram for explaining comparison between HTML sources of two existing WWW page samples according to a third embodiment;

FIG. 11 is a flowchart showing a flow of automatic generation of a marked-up page according to the third embodiment;

FIG. 12 shows an example of an automatically-generated marked-up page according to the third embodiment; and

FIG. 13 shows an example of a JSP source according to a fourth embodiment.

### DESCRIPTION OF THE PREFERRED EMBODIMENTS

### First Embodiment

Now, embodiments of the present invention will be described referring to the drawings. First, will be described a configuration and functions of a user interface combining system, which includes a data extraction definition information generation device, according to a first embodiment. Then, after clarifying the role of a data extraction definition function in the user interface combining system, will be described details of data extraction definition information required for the data extraction definition function. Then, details of the present embodiment will be described.

The data extraction definition information used in user interface combining process of the present embodiment is automatically generated from a marked-up page. A marked-up page is generated by using a sample of an HTML source of a WWW page as an object of data extraction and by inserting special character strings called “marks” into a place of an object to be extracted. A mark is a character string that includes information specifying an extracting location and a data item to be extracted.

The data extraction definition information generation device of the present embodiment automatically generates data extraction definition information by analyzing a marked-up page first to specify locations of marks and then to specify information required for generating the data extraction definition information based on the marks and character strings before and after the marks. Thus, the present embodiment provides a user (i.e., a system administrator) with an environment for automatically generating data extraction definition information from a marked-up page. As a result, the user can easily obtain the data extraction definition information that is indispensable for generating a combined page.

An administrator of the conventional user interface combining system should generate data extraction definition information directly from a WWW page. On the other hand, in the present embodiment, data extraction definition information is generated automatically when the administrator generates at least a marked-up page, which can be easily generated from a WWW page.

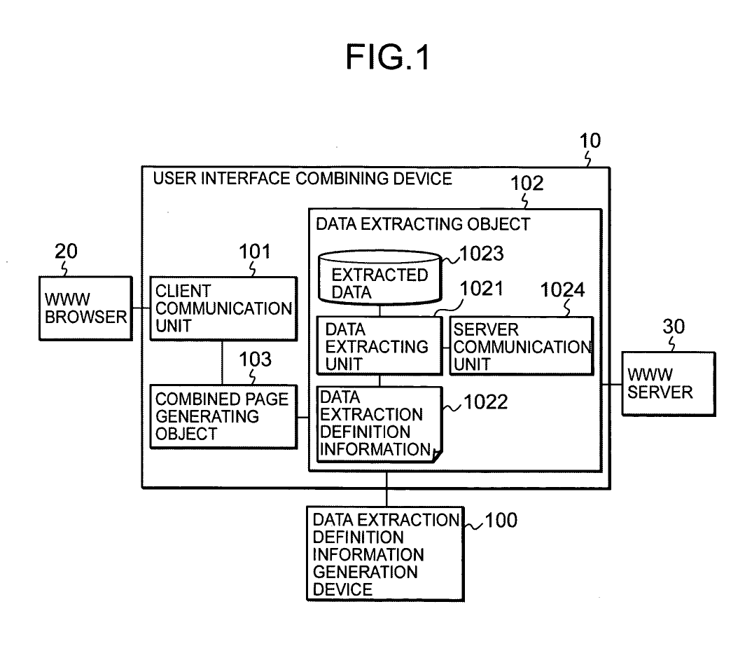

FIG. 1 is a block diagram showing a configuration of the whole system according to the present embodiment.

The system of the present embodiment comprises a user interface combining device 10, WWW servers 30 that provide WWW services, a WWW browser 20 for browsing contents provided as the WWW services by the WWW servers 30, and a data extraction definition information generation device 100.

In response to a request from the WWW browser 20 as a client, the user interface combining device 10 accesses a plurality of WWW servers 30 to obtain WWW pages provided by those WWW servers 30. Then, the user interface combining device 10 extracts desired information from the obtained WWW pages, and generates one WWW page based on the extracted information. Then, the user interface combining device 10 returns the generated page as a combined page (which becomes a combined user interface) combined from WWW applications provided by the WWW servers, to the WWW browser 20, i.e., the sender of the request.

The user interface combining device 10 comprises: a client communication unit 101 as an interface with the WWW browser 20; data extracting objects 102 that access the WWW servers 30 to extract and accumulates information required for generating a combined page; and a combined page generating object 103 that generates a combined page based on extracted data accumulated.

The client communication unit 101 receives a request for generation of a combined page from the WWW browser 20, notifies the combined page generating object 103 of the received request, and sends a combined page generated by the combined page generating object 103 to the WWW browser 20.

The combined page generating object 103 generates the combined page. Further, the combined page generating object 103 receives the request for generation of the combined page through the client communication unit 101 and delivers the received request to the data extracting objects 102. Further, the combined page generating object 103 has combined page definition information that defines a method of laying out the combined page, generates the combined page using data extracted by the data extracting objects 102 according to the request for generation of the combined page, and sends the generated combined page to the WWW browser 20 through the client communication unit 101.

The data extracting objects 102 are prepared as many as the WWW servers 30 connected to the user interface combining device 10. Here, one of the data extracting object 102 will be taken and described representatively. A data extracting object 102 comprises a data extracting unit 1021, a data extraction definition information 1022, an extracted data holding unit 1023 for holding extracted data, and a server communication unit 1024.

The server communication unit 1024 is an interface with a WWW server 30, and sends a request for obtaining a WWW page to the WWW server 30 and consequently receives the WWW page generated and returned by the WWW server 30.

The data extraction definition information 1022 is information that indicates a method of extracting required information from an obtained WWW page.

The data extracting unit 1021 extracts required information from an obtained WWW page in accordance with the data extraction definition information 1022, and accumulates the extracted data in the extracted data holding unit 1023.

The data extraction definition information generation device 100 generates the data extraction definition information from a WWW page received by the server communication unit 1024. Namely, the data extraction definition information generation device 100 inserts information that defines data items of the extraction destination into parts to be extracted out of the object user interface information, to prepare user interface information added with data extraction definition. Then, the data extraction definition information generation device 100 generates data extraction definition information, which defines extraction locations and the data items of the extraction destination, based on the user interface information added with data extraction definition. Details of this processing will be described below.

Before describing a detailed configuration of the data extraction definition information generation device 100, will be described details of the data extraction definition information 1022 of the present embodiment as well as a WWW page that becomes an object of extraction.

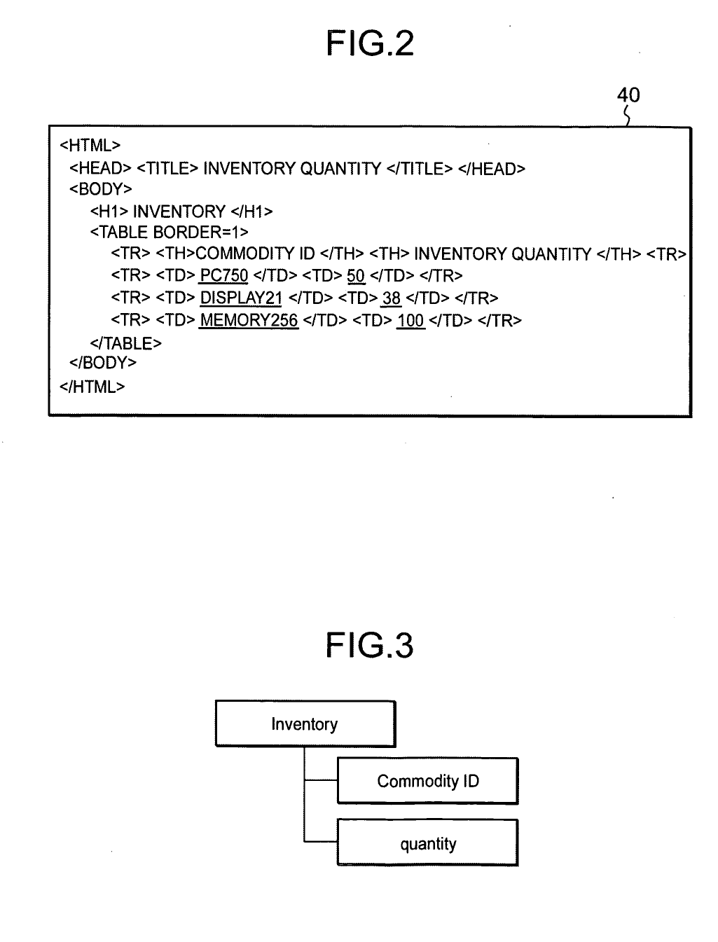

FIG. 2 shows an example of an HTML source 40 of an existing WWW page provided by a WWW server 30. Such a WWW page becomes an object of a combined page. This example of existing WWW page is provided as a user interface of an inventory management system. This WWW page indicates quantities of commodities in stock under management and has the table structure of three record lines each including a commodity ID and an inventory quantity of that commodity. Information of commodity IDs and respective inventory quantities is obtained as the information required for generating a combined page (In FIG. 2, the underlined parts correspond to the information).

Data extracted by the data extracting unit 1021 from a WWW page obtained through the server communication unit 1024 is accumulated in the extracted data holding unit 1023. FIG. 3 shows an example of structure of the data accumulated in the extracted data holding unit 1023. In the present embodiment, a record indicating an inventory quantity is accumulated as “inventory”, a data item indicating a commodity ID as “goods ID”, and a data item indicating an inventory quantity as “quantity”.

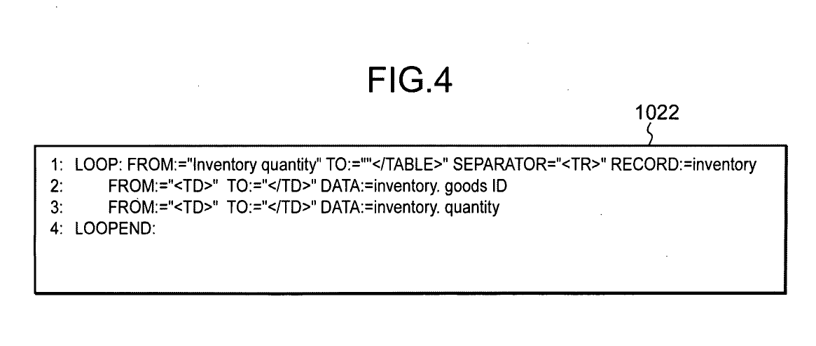

FIG. 4 shows an example of the data extraction definition information 1022, which gives definition of extraction of commodity IDs and respective inventory quantities from the HTML source 40. For the sake of explanation, line numbers are given to the left ends.

The 1st line defines repetitive one-by-one extraction of records each having data items, the commodity ID and the inventory quantity. In detail, the 1st line defines that, in a range between a character string “inventory quantity” (which is defined by FROM) and a character string “</TABLE>” (which is defined by TO), record parts each starting from a character string “<TR>” (which is defined by SEPARATOR) are repetitively extracted into a record named “inventory” (which is defined by RECORD) in the extracted data holding unit 1023.

The 2nd and 3rd lines define extraction of the commodity ID and the inventory quantity in the repetitive processing. The 2nd line defines that a character string (which is information of the commodity ID) lying between a character string “<TD>” defined by FROM and a character string “</TD>” defined by TO is extracted into the data item named “goodsID” of an “inventory” record. The 3rd line defines that a character string (which is information of the inventory quantity) lying between a character string “<TD>” (in a position next to the preceding “</TD>”) defined by FROM and a character string “</TD>” defined by TO is extracted into the data item named “quantity” of the “inventory” record.

The 4th line defines that the processing of extracting the data items in a record ends at the 3rd line.

A procedure for the data extracting unit 1021 to extract data in the data structure shown in FIG. 3 from the HTML source 40 into the data holding unit 1023 in accordance with the data extraction definition information 1022 is described in detail in a patent document 1 (Japanese Non-examined Patent Laid-open No. 2003-345697), and therefore is not described here. However, according to the patent document 1, the system administrator generates the data extraction definition information 1022.

Now, using the sample of WWW page shown by the HTML source 40, will be described a method in which the data extraction definition information generation device 100 automatically generates the data extraction definition information 1022.

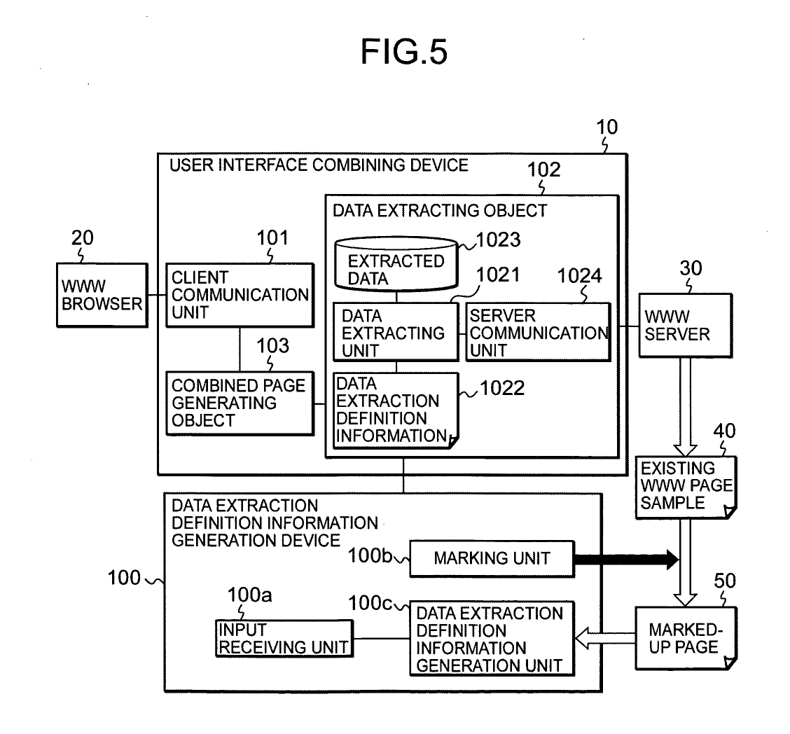

FIG. 5 is a diagram for explaining a functional configuration of the data extraction definition information generation device and for explaining processing of automatic generation of the data extraction definition information 1022 by the data extraction definition information generation device 100.

As shown in the figure, the data extraction definition information generation device 100 of the present embodiment comprises an input receiving unit 100a for receiving an instruction and input from the user, a marking unit 100b for adding below-mentioned “marks” to an HTML source 40 of a WWW page sample obtained, and a data extraction definition information generation unit 100c.

The data extraction definition information generation unit 100c automatically generates the data extraction definition information 1022 from a marked-up page 50 generated by the marking unit 100b.

Here, the marked-up page 50 means an HTML source 40 of an existing WWW page sample into which special character strings called marks have been inserted.

As described above, a mark is a character string used for indicating a location from which data should be extracted in an HTML source 40 or for indicating a format of accumulation of extracted data in the extracted data holding unit 1023.

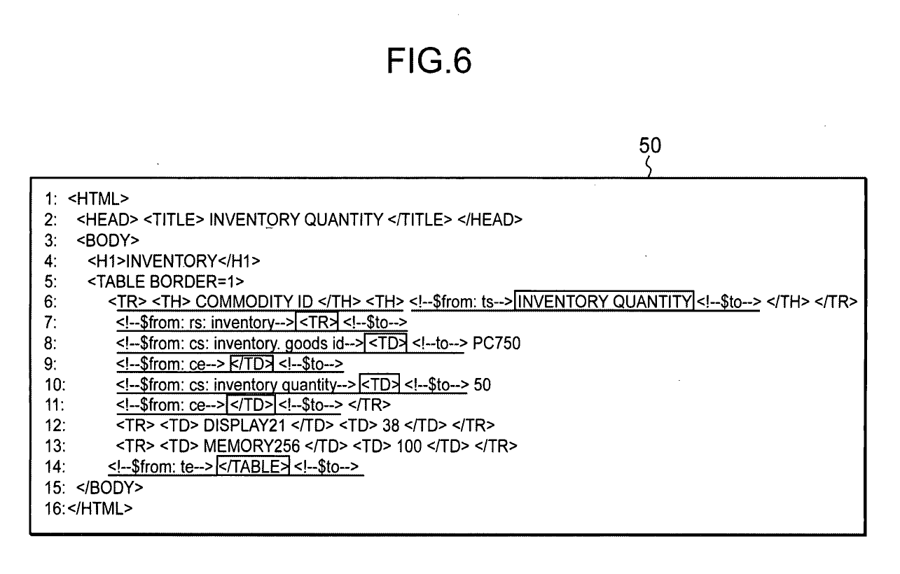

FIG. 6 shows an example of a marked-up page 50 that is obtained by inserting such marks into an HTML source 40 of an existing WWW page sample. Now, will be described kinds of marks and how to use them. For the sake of explanation, FIG. 6 has line numbers at the left ends of lines.

In FIG. 6, a mark is shown as a comment tag of HTML, and expressed as a character string enclosed by “<!--” and “-->”. In the figure, a character string meeting this condition is shown as an underlined character string.

There are two types of marks, $from and $to. As basic use of the marks, a $from-type mark and a $to-type mark are placed respectively just before and after a character string (shown as a character string enclosed by a rectangle) that becomes a keyword for indicating a position of a character string as an object of extraction.

Further, $from-type marks have various properties. Each property is described by adding property information after a colon (:) placed at the rear end of a $from-type mark.

Property information ts indicates that the preceding $from-type mark specifies the starting character string and property information te indicates that the preceding $from-type mark specifies the ending character string in extracting records repeatedly (Hereinafter, the property information ts is referred to as the ts property. Other property information is referred to similarly). Property information rs indicates that the $from-type mark concerned specifies the starting character string of a record in extracting records repeatedly. Property information cs indicates that the $from-type mark concerned specifies a starting character string in extracting a data item of a record. And, property information ce indicates that the $from-type mark concerned specifies an ending character string when a data item of a record is extracted.

Further, the rs property indicates a mark for holding information of a record name of the extraction destination, and the cs property indicates a mark for holding information of a record name and a data item name of the extraction destination.

In the 6th line of the marked-up page 50, the $from mark of the ts property and the $to mark enclose a character string “inventory quantity”. This corresponds to the fact that, in the 1st line of the data extraction definition information 1022 shown in FIG. 4, FROM defines “inventory quantity” as the starting character string for the repetitive processing.

In the 7th line of the market page 50, the $from mark of the rs property and the $to mark enclose a character string “<TR>”. This corresponds to the fact that, in the 1st line of the data extraction definition information 1022 shown in FIG. 4, SEPARATOR defines “<TR>” as the starting character string of a record.

Further, also the $from mark in the 7th line designates “inventory” as record information. This corresponds to the fact that, in the 1st line of the data extraction definition information 1022 shown in FIG. 4, DATA defines “inventory” as the record of the extraction destination.

In the 8th line of the marked-up page 50, the $from mark of the cs property and the $to mark enclose a character string “<TD>”. This corresponds to the fact that, in the 2nd line of the data extraction definition information 1022 shown in FIG. 4, FROM defines “<TD>” as the starting character string of the read position of the data item.

Further, also the $from mark in the 8th line designates “inventory.goodsID” as the information of the record and the data item. This corresponds to the fact that, in the 2nd line of the data extraction definition information 1022 shown in FIG. 4, DATA sets the data item “goodsID” of the record “inventory” as the extraction destination.

In the 9th line of the marked-up page 50, the $from mark of the ce property and the $to mark enclose a character string “</TD>”. This corresponds to the fact that, in the 2nd line of the data extraction definition information 1022 shown in FIG. 4, TO defines “</TD>” as the ending character string for the repetitive processing.

Similarly to the 8th and 9th lines, the 10th and 11th lines of the marked-up page 50 define information on reading of the data item in the 3rd line of the data extraction definition information 1022 shown in FIG. 4.

In the 14th line of the marked-up page 50, the $from mark of the te property and the $to mark enclose a character string “</TABLE>”. This corresponds to the fact that, in the 1st line of the data extraction definition information 1022 shown in FIG. 4, TO defines “</TABLE>” as the ending character string for the repetitive processing.

Thus, as described above, the marked-up page 50 can define all the required and only required information to be contained in the data extraction definition information 1022.

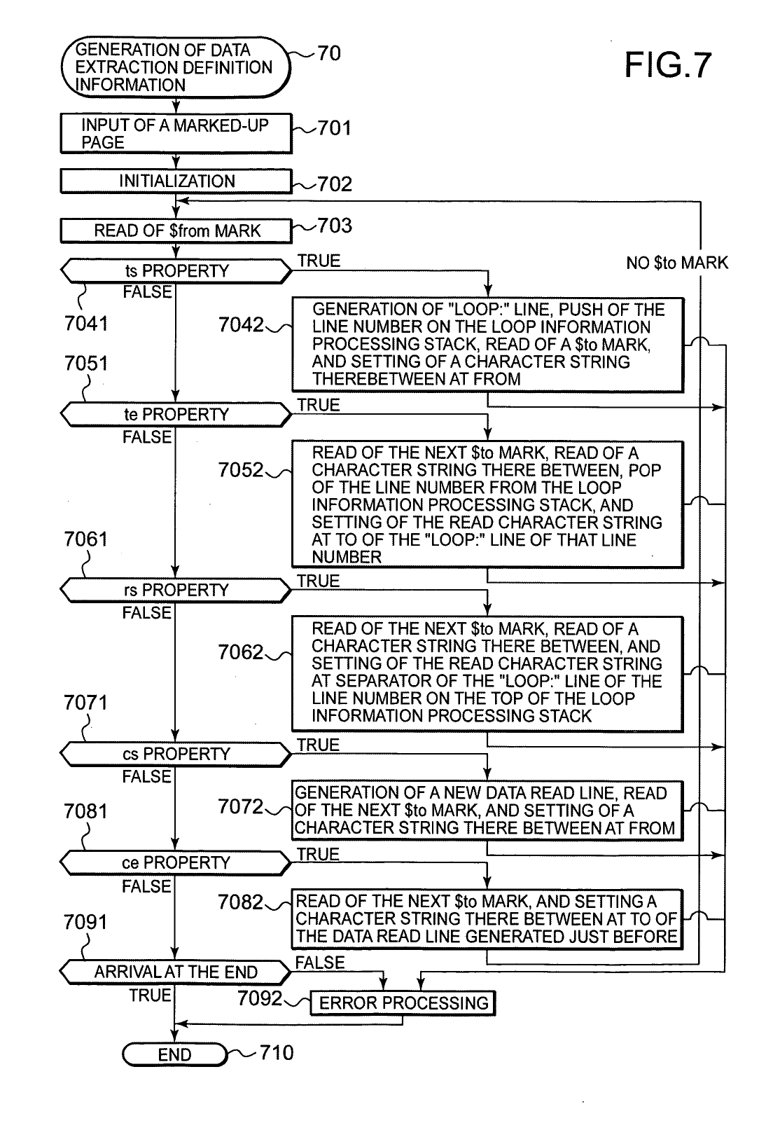

FIG. 7 is a flowchart showing a flow in the data extraction definition information generation unit 100c that generates the data extraction definition information 1022 from a marked-up page 50. Now, referring to the flowchart of FIG. 7, will be described a procedure of the data extraction definition information generation unit 100c for generating the data extraction definition information 1022 from the above-described marked-up page 50.

The data extraction definition information generation unit 100c is provided with a below-mentioned loop information processing stack (not shown) for storing a line number of a LOOP: line in the data extraction definition information 1022.

First, the data extraction definition information generation unit 100c receives input of the marked-up page 50 (Step 701) and performs an initialization process (Step 702). In the initialization process, the loop information processing stack is emptied, and a cursor location for reading the marked-up page 50 is set at the top of the marked-up page 50.

Then, the data extraction definition information generation unit 100c detects a $from-type mark in the closest location after the current read cursor location, and moves the read cursor location to the detected location to start reading (Step 703). Depending on the property of the $from, the next process is branched as follows. When the process ends, the processing is repeated from Step 703 again.

In the case of the ts property, the data extraction definition information generation unit 100c generates a “LOOP:” line in the data extraction definition information 1022, and stores (pushes) the line number of the “LOOP:” line in the data extraction definition information 1022 into the loop information processing stack. Next, the data extraction definition information generation unit 100c detects a $to mark that appears first after the current cursor location. Then, a character string lying between the former cursor location and the location at which the $to mark is detected is set at FROM in the data extraction definition information 1022. And, the data extraction definition information generation unit 100c moves the current cursor location to the location just after the $to mark (Steps 7041 and 7042).

In the case of the te property, the data extraction definition information generation unit 100c detects a $to mark that appears first after the current cursor location, and reads a character string lying between the former cursor location and the location at which the $to mark is detected. Then, the data extraction definition information generation unit 100c takes out (pops) the line number stored in the loop information processing stack and sets the read character string at TO in the “LOOP:” line of that line number in the data extraction definition information 1022. Then, the data extraction definition information generation unit 100c moves the current cursor location to the location just after the $to mark (Steps 7051 and 7052).

In the case of the rs property, the data extraction definition information generation unit 100c detects a $to mark that appears first after the current cursor location and reads a character string lying between the former cursor location and the location at which the $to mark is detected. Then, in the data extraction definition information 1022, this read character string is set at SEPARATOR in the “LOOP:” line specified by the line number stored in the loop information processing stack. Then, the data extraction definition information generation unit 100c moves the current cursor location to the location just after the $to mark (Steps 7061 and 7062).

In the case of the cs property, the data extraction definition information generation unit 100c detects a $to mark that appears first after the current cursor location. Then, a character string lying between the former cursor location and the location at which the $to mark is detected is set at FROM in a new data read line in the data extraction definition information 1022. Then, the data extraction definition information generation unit 100c moves the current cursor location to the location just after the $to mark (Step 7071 and 7072).

In the case of the ce property, the data extraction definition information generation unit 100c detects a $to mark that appears first after the current cursor location. Then, a character string lying between the former cursor location and the location at which the $to mark is detected is set at TO in the just-generated data read line in the data extraction definition information 1022. Then, the data extraction definition information generation unit 100c moves the current cursor location to the location just after the $to mark (Steps 7081 and 7082).

When the end of the marked-up source 50 is reached without detecting a $from-type mark in the above processing of trying to detect a $from-type mark, then the processing is ended and the data extraction definition information generation unit 100c outputs the generated data extraction definition information 1022 (Steps 7091 and 710).

In the case where a property of a $from mark does not meet any of the above-mentioned properties or where the end of the marked-up source 50 is reached without detecting a $to mark while trying to detect a $to mark, it is judged that the marked-up source 50 does not follow the markup rules, and the data extraction definition information generation unit 100c ends the processing without outputting the data extraction definition information 1022 (Steps 7092 and 710).

Thus, according to the present embodiment, the data extraction definition information generation unit 100c can read a marked-up source 50, and, based on marks added to the source 50, identify locations of character strings as objects to be extracted and those character strings' meanings in the data extraction definition information. Accordingly, based on the identification results, the data extraction definition information generation unit 100c can generate the data extraction definition information in accordance with previously-provided rules.

In other words, according to the present embodiment, only if the user as the administrator of the user interface combining system generates a marked-up source 50 and inputs the generated source 50 to the data extraction definition information generation device 100, the data extraction definition information generation device 100 can automatically generate the data extraction definition information 1022.

Here, a marked-up source 50 is generated as follows. Namely, marks are received through the input receiving unit 100a provided to the data extraction definition information generation device 100 from the user as the administrator of the user interface combining device 10. Then, the marking unit 100b adds the received marks to an HTML source 40 of an existing WWW page sample, to generate a marked-up source 50.

Since a marked-up source 50 can be generated by easy processing according to the conventional techniques, generation of a marked-up source 50 is much easier than direct generation of the data extraction definition information 1022. Thus, according to the present embodiment, it is possible to develop easily the data extraction definition information 1022 from an HTML source 40 of an existing WWW page sample.

In the present embodiment, a WWW page as an object of extraction is not limited to one generated by HTML. For example, a WWW page may be a CSV file.

Further, the data extraction definition information generation device 100 of the present embodiment is implemented by an ordinary information processing device comprising a CPU and a memory. The memory stores an HTML source 40 of an existing WWW page sample obtained from a WWW server 30, a marked-up page 50, programs for realizing various functions, and the like. The CPU reads the programs from the memory at need, and executes the programs to realize the above-mentioned functions.

In the present embodiment, the user interface combining device 10 and the data extraction definition information generation device are described as separate devices. However, this configuration is not essential. For example, the functions of these two devices may be realized in one information processing device.

### Second Embodiment

In the first embodiment, the user as the administrator of the user interface combining system generates a marked-up source 50. In the case where a WWW page as an object of extraction is a WWW page generated in HTML, it is possible to generate a marked-up page 50 automatically, taking parts other than tags as objects of extraction. A second embodiment will be described taking the example where an object of extraction is a WWW page generated in HTML and a marked-up source 50 is generated automatically also.

A user interface combining system of the present embodiment has a configuration that is basically similar to the user interface combining system of the first embodiment. However, the data extraction definition information generation device 100 of the present embodiment further comprises a marked-up page generation unit (not shown).

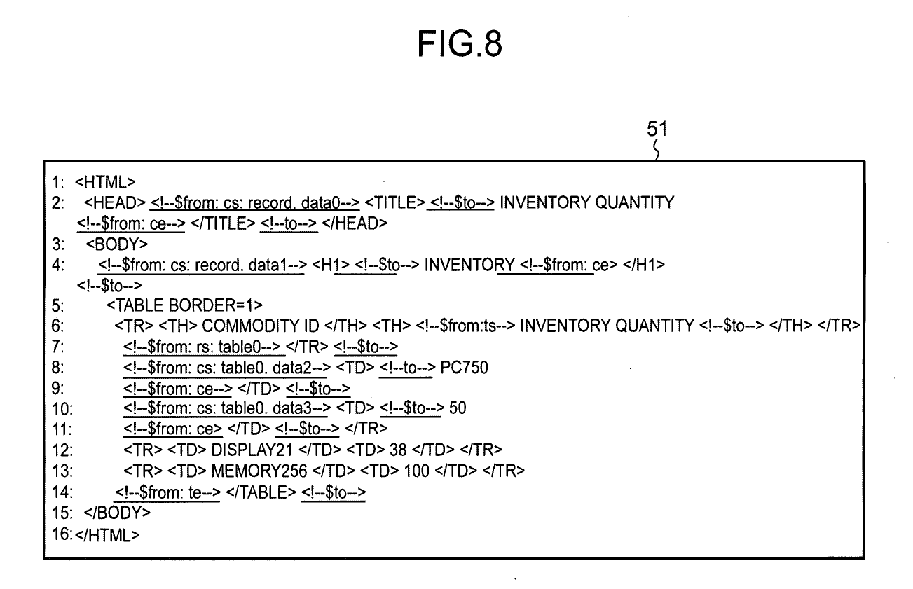

FIG. 8 shows an example of a marked-up page 51, which is automatically generated from an HTML source 40 of an existing WWW page sample, by extracting parts other than tags from the source 40. For the sake of explanation, each mark part is shown as an underlined part, and a line number is shown at the left end of each line.

In the present embodiment, the data extraction definition information generation unit 100c generates the data extraction definition information from this marked-up page 51 instead of the marked-up page 50 of the first embodiment.

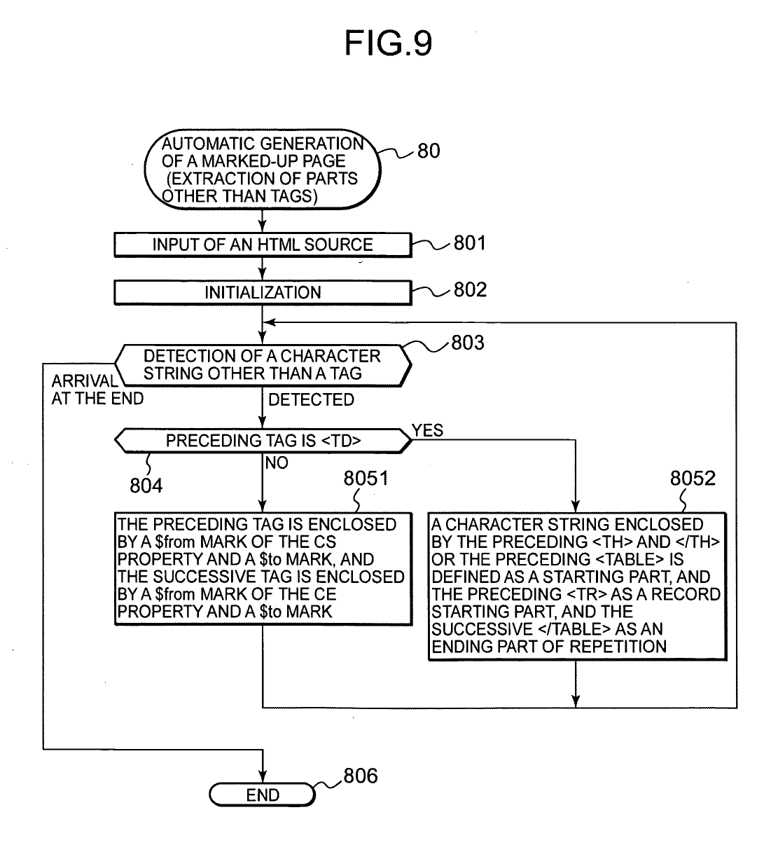

FIG. 9 is a flowchart showing a flow of processing in the case where the marked-up page generation unit generates a marked-up page 51 automatically from an HTML source 40 of an existing WWW page sample, by extracting parts other than tags from the source 40. Referring to the flowchart of FIG. 9, will be described the procedure of the marked-up page generation unit for automatically generating a marked-up page, extracting parts other than tags from the source.

Here, the marked-up page generation unit is provided with the below-mentioned counter for a record name (hereinafter, referred to as the record name counter) and the below-mentioned counter for a data item name (hereinafter, referred to as the data item name counter).

First, the marked-up page generation unit receives input of an HTML source 40 of an existing WWW page sample as an object of extraction (Step 801) and performs an initialization process (Step 802). In the initialization process, a location of the read cursor for reading the HTML source 40 of the existing WWW page sample is set at the top of the sample, and the record name counter and the data item name counter are set to 0.

Then, the marked-up page generation unit detects a character string in the closest location after the current read cursor location, among character strings other than the tags (Step 803). A character string other than the tags is a character string that is not enclosed by “<” and “>”.

When no character string is detected, the marked-up page generation unit ends the processing and outputs the marked-up page 51 that has been generated at this point (Step 806).

When a character string is detected, the marked-up page generation unit examines whether the tag just before the character string is “<TD>” (Step 804).

In the case where the tag just before the detected character string is not “<TD>”, then, in the marked-up page 51, the tag just before the character string is defined by enclosing with a $from mark of the cs property and a $to mark, and the tag just after the character string by enclosing with a $from mark of the ce property and a $to mark. At that time, in the $from mark of the cs property, “record” is defined as the name of the extraction destination, and “data” added with the data item name counter value (after conversion to a character string) is defined as a data item name of the extraction destination. Then, the data item name counter value is incremented by one (Step 8051).

In the case where the tag just before the detected character string is “<TD>”, then, in the marked-up page 51, a character string enclosed by the preceding “<TH>” and “</TH>” or the preceding “<TABLE>” is defined as a starting part of repetition by enclosing with a $from mark of the ts property and a $to mark.

At that time, “table” added with the record name counter value (after conversion to a character string) is defined as a record name. For example, in the 7th line of the marked-up page 51 shown in FIG. 8, the $from mark of the rs property defines a record name “table0”.

Then, the successive “/<TABLE>” is defined as an ending part of the repetition by enclosing a $from mark of the te property and a $to mark. The processing of inserting the marks with respect to the above “</TABLE>” for defining the ending part of the repetitive processing is not performed in the case where the marks have been already set with respect to the same character string.

Last, the “<TD>” tag just before the detected character string is defined by enclosing a $from mark of the cs property and a $to mark, and the “</TD>” tag just after the detected character string by enclosing a $from mark of the ce property and a $to mark.

At that time, the $from mark of the cs property defines “table” added with the record name counter value (after conversion to a character string) as a record name of the extraction destination, and defines “data” added with the data item name counter value (after conversion to a character string) as a data item name of the extraction data item name. For example, in the 8th line of the marked-up page 51 shown in FIG. 8, the $from mark of the cs property defines “table0” as a record name and “data2” as a data item name. Thereafter, the data item name counter value is incremented by one.

Then, in the case where no “<TD>” tag exists before the “</TR>” that appears first after the current cursor location, the marked-up page generation unit moves the current cursor location to the location just after the “</TABLE>” tag after the current cursor location, and increments the record name counter value by one.

In the case where a “<TD>” tag exists before the “</TR>” that appears first after the current cursor location, the marked-up page generation unit moves the current cursor location to the location just after “</TD>” that is located just after the current cursor location (Step 8052).

The, the processing is repeated from Step 803 again.

In comparison with the marked-up page 50 shown in FIG. 6, the automatically-generated marked-up page 51 shown in FIG. 8 is added with new marks in the 2nd and 4th lines, and further has the automatically generated names such as “record”, “table0” and “data0” as designations of a record and data items by the $from marks.

Thus, in the case where a marked-up page 51 is generated by automatically marking up the parts other than the tags as objects of extraction from an HTML source 40 of an existing WWW page sample, there is a demerit that unnecessary parts become extraction objects and names of extraction objects become mechanically assigned ones.

Accordingly, in the present embodiment, the user as the administrator of the user interface combining system performs processing such as deletion of the unnecessary parts and change of the names of the record and data items after automatic generation of a marked-up page 51. However, in the case where an object of extraction is a WWW page having quite a large number of items, automatic generation of a marked-up page has merits that greatly exceed the demerits of such additional processing. Thus, on the whole, it is considered that employment of this system will improve efficiency of developing a marked-up page.

According to the present embodiment, it is possible to generate a marked-up page automatically from an HTML source of an existing WWW page as an object of extraction, and to save time and effort for the user as the administrator of the user interface combining system to generate a marked-up page.

Although, as described above, it is required to delete marks resulting from unnecessary extraction objects and to change a record name and data item names into desired ones, efficiency of developing a marked-up page is higher than a method in which the user as the administrator of the user interface combining system generates the marked-up page manually from the beginning. Thus, considering, as a whole, generation of the data extraction definition information 1022 from a WWW page through generation of a marked-up page, it is possible to attain higher development efficiency.

The present embodiment assumes that a repetitive processing part starts from “<TABLE>” and ends at “</TABLE>”, and that a record part starts from “<TR>”. However, candidates of such character strings can be determined in advance depending on a format of a WWW page as an object, to generate a marked-up page appropriately. Determination of such character strings is performed by the user as the administrator of the user interface combining system through the input receiving unit 1025a.

### Third Embodiment

Next, will be described an embodiment in which extraction objects in a WWW page are automatically determined. In the present embodiment, to generate a marked-up page automatically, a plurality of samples of a WWW page as an object of extraction are used, these samples are compared with one another, and character strings of different parts become extraction objects to insert marks before and after each of such character strings. It is assumed that an object WWW page is generated in HTML.

Basically, a user interface combining system of the present embodiment is similar to the first and second embodiments. Further, a marked-up page generation unit of a data extraction definition information generation device 100 of the present embodiment is basically similar to the second embodiment. However, in addition to the functions of the second embodiment, the marked-up page generation unit is further provided with a WWW page comparing function.

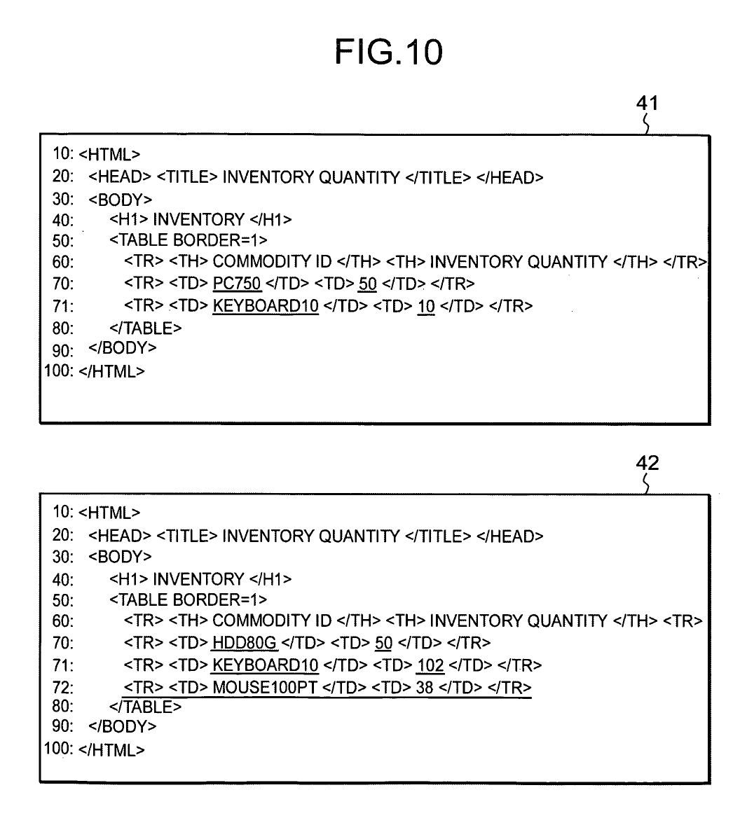

FIG. 10 is a diagram for explaining comparison between HTML sources 41 and 42 of two existing WWW page samples. Here, character string parts different in the two samples are underlined.

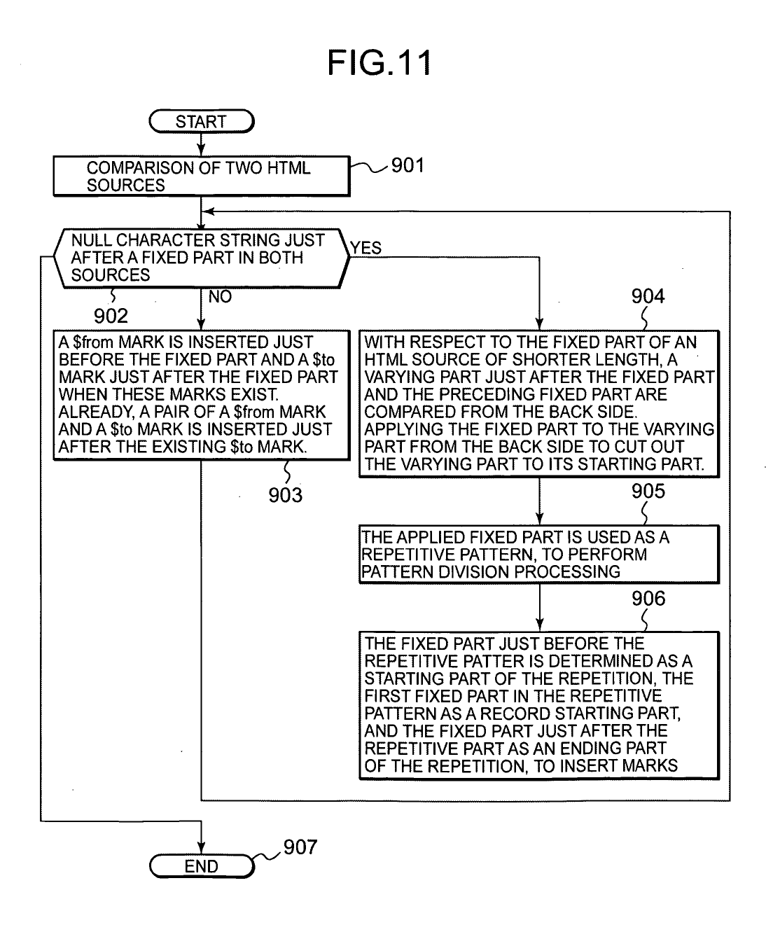

FIG. 11 is a flowchart showing a flow of automatic generation of a marked-up page by comparison of HTML sources of WWW samples.

Now, referring to the flowchart of FIG. 11, will be described a method in which the marked-up page generation unit generates a marked-up page 52 by comparison of the HTML sources 41 and 42 of the two existing WWW page samples. In the present embodiment, the data extraction definition information generation unit 100c uses the marked-up page 52 to generate data extraction definition information 1022.

The marked-up page generation unit compares the HTML sources 41 and 42 of the two existing WWW page samples sequentially from their tops and classifies parts of the sources into common character string parts (fixed parts) and non-common parts (varying parts) (Step 901).

Then, for each fixed part, the marked-up page generation unit examines a varying part just after the fixed part (Step 902).

In the case where the varying part in question is not a null character string in both sources 41 and 42, the marked-up page generation unit inserts a $from mark of the cs property just before the fixed part just before the varying part and a $to mark just after the fixed mark in one of the objects under comparison, i.e., the HTML sources 41 and 42 of the existing WWW page samples, and inserts a $from mark of the ce property just before a fixed part just after the varying part in question and a $to mark just after that fixed part, to generate a marked-up page 52. At that time, in the case where marks have been already inserted, a pair of a $from mark and a $to mark is inserted into a location just after the existing $to mark (Step 903).

In the case where the varying part just after the fixed part in one of the sources 41 and 42 is a null character string, the marked-up page generation unit performs detection processing on the varying part just after the fixed part in the other source, to judge whether a repetitive expression is included. In detail, the character string of the 72nd line of the HTML source 42 (shown in FIG. 10) of the existing WWW page sample becomes the object of the detection.

The marked-up page generation unit compares the varying part character string (i.e., the object of the detection) with a group of the preceding fixed parts from the back side. In detail, the fixed parts are compared in the order of “</TD></TR>”, “</TD><TD>” and “<TR><TD>”. This is repeated until the first character string in the object varying part matches up with a fixed part. When the length of the object varying part is so large that there remains no fixed part to be matched up, then the comparison is repeated from the fixed part just before the object varying part (Step 904).

The marked-up page generation unit judges whether a repetitive pattern is included in a group of fixed parts cut out from the object varying part. When a repetitive pattern is included, that pattern is made to be a repetitive pattern of the marked-up page 52. When no repetitive pattern is included, then the very group of fixed parts cut out from the object varying part is made to be a repetitive pattern of the marked-up page 52 (Step 905).

Then, as a starting part of the repetition, the fixed part just before the repetitive part is enclosed by a $from mark of the ts property and a $to mark, to generate the marked-up page 52. As a starting part of a record, the first fixed part in the repetitive pattern is enclosed by a $from mark of the rs property and a $to mark, to generate the marked-up page 52. As an ending part of the repetition, the fixed part just after the repetitive pattern is enclosed by a $from mark of the te property and a $to mark, to generate the marked-up page 52. Then, similarly to Step 903, marks are inserted into the other parts of the repetitive pattern, to generate the marked-up page 52.

Here, a record name and data item names to be set in the marks are set in formats similar to the second embodiment (Step 906).

The above-described processing is performed for each fixed part sequentially from the tops of the sources. When there remains no fixed part to be processed, the processing is ended and the marked-up page 52 is outputted.

In the above description, the HTML sources 41 and 42 of the two existing WWW page samples are inputted. However, more WWW pages may be inputted to be comparison objects. In that case, the marked-up page generation unit of the present embodiment can extract varying parts more properly, and can generate a more appropriate marked-up page automatically.

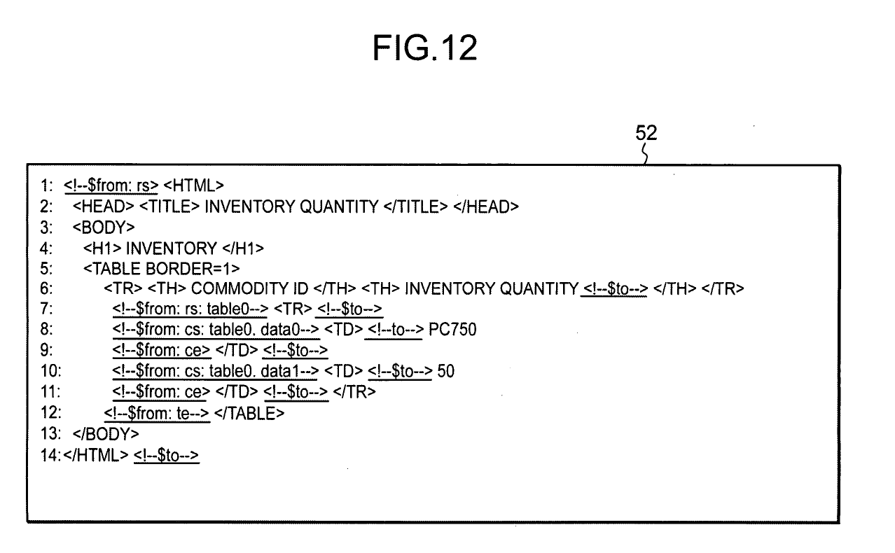

FIG. 12 shows an example of a marked-up page 52 outputted according to the present embodiment in the case where the HTML sources 41 and 42 (shown in FIG. 10) of the two existing WWW page samples are inputted.

According to the present embodiment, similarly to the marked-up page 51 (shown in FIG. 8) outputted according to the method of the second embodiment, a record name and data item names become mechanically assigned ones. Similarly to the second embodiment, in the present embodiment also, it is possible to generate and output a marked-up page without extracting unnecessary parts (for example, the marks enclosing “inventory” in the 4th line of FIG. 8 and enclosing “inventory quantity” in the 6th line of FIG. 8).

In that case, the user as the administrator of the user interface combining system can change the outputted marked-up page 52 into a suitable marked-up page only by changing the record name and the data item names in the outputted marked-up page 52 into desired names. Then, using the changed marked-up page, the data extraction definition information generation unit 100c can obtain the data extraction definition information 1022.

According to the present embodiment, a suitable marked-up page can be generated automatically. It is possible to promote further automation all over the processing of generating the data extraction definition information 1022. As a result, efficiency of development of the data extraction definition information 1022 becomes higher.

### Forth Embodiment

In the case where JSP (Java Server Pages) is employed in processing of a WWW server that provides a WWW page as an object of extraction, the JSP source can be used to output a marked-up page automatically.

JSP is described in detail in the WWW page, “JavaServer pages (TM) Technology” (http://java.sun.com/products/jsp/). According to JSP, a script in an HTML file describes processing, the script is executed on the side of the WWW server for each request from a WWW browser, and script parts in the HTML file are replaced with the respective execution results before sending to the WWW browser. According to JSP, it is easy to understand relation between an HTML file and processing, and thus, it is possible to generate dynamic contents, being conscious of actual display images.

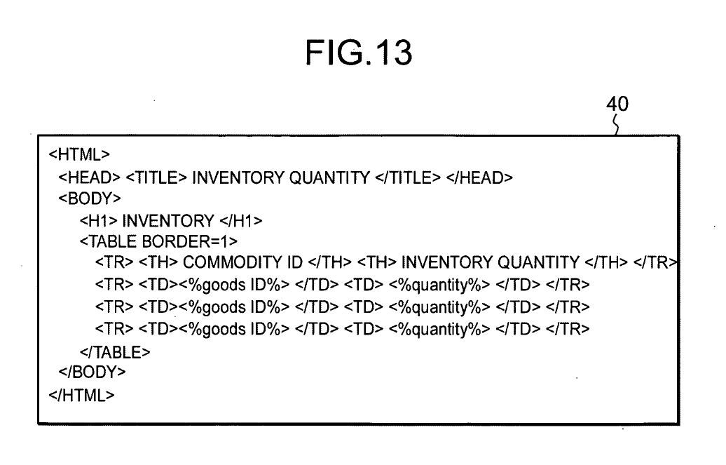

FIG. 13 shows an example of JSP source for outputting a WWW page similar to one generated by the HTML source shown in FIG. 2.

As described above, a JSP source has a format in which program processing is inserted in an HTML source. In FIG. 13, a part enclosed by “<%” and “%>” corresponds to a program processing part. Parts of the HTML format other than program processing parts are outputted as an HTML source as they are.

The present embodiment has a configuration basically similar to the third embodiment. However, at generation of a marked-up page, the marked-up page generation unit of the data extraction definition information generation device 100 of the present embodiment does not compare a plurality of marked-up pages but utilizes a property of a JSP source to extract varying parts.

Namely, according to the present embodiment, among program processing parts, a part enclosed by “<%=” and “%>” becomes a part whose content is evaluated to output a character string resulting from the evaluation. Accordingly, for outputting a marked-up page based on a JSP source, the marked-up page generation unit processes a part enclosed by “<%=” and “%>” similarly to a varying part in the third embodiment.

Further, as for repetitive processing, a JSP source defines loop processing by a program processing part enclosed by “<%” and “%>”. Thus, in the case where there is a part enclosed by “<%=” and “%>” within a loop, that part can be considered as an object of extraction in repetitive processing. Namely, by defining a portion of description in HTML just before the loop processing as a starting part of repetition processing, the first part of HTML output as a starting part of a record, and a portion of description in HTML just after the loop as an ending part of the repetitive processing, the marked-up page generation unit can perform processing similar to the third embodiment, to generate a desired marked-up page.

According to the marked-up page generation unit of the data extraction definition information generation device 100 of the present embodiment, it is possible to generate automatically a marked-up page in which locations to be extracted and locations of repetitive processing are specified more appropriately than the second and third embodiments. As a result, efficiency of developing the data extraction definition information 1022 is improved.

As described above, the above-described data extraction definition information generation devices 100 of the second, third and fourth embodiments automatically generate marked-up pages according to the respective methods, and generate the data extraction definition information 1022 based on the generated marked-up pages. However, the data extraction definition information 1022 may be generated directly from an HTML source 40 of an existing WWW page sample.

In detail, to generate marks corresponding to a starting part of repetition (i.e., a part enclosed by $from:ts and $to), a “FROM” definition of “LOOP” is generated. To generate marks corresponding to a delimiter part of repetition (i.e., a part enclosed by $from:rs and $to), a “SEPARATOR” definition of “LOOP” is generated. To generate marks corresponding to an ending part of repetition (i.e., a part enclosed by $from:cs and $to), a $FROM” definition is generated. And, to generate marks corresponding to an ending part of an item (i.e., a part enclosed by $from:ce and $to), a “TO” definition is generated.

Further, in the first-forth embodiments, it is assumed that the data extracting unit 1021 performs data extraction processing from a plurality of WWW pages in accordance with the data extraction definition information 1022. Instead of generating the data extraction definition information 1022, however, it is possible to generate a program whose codes describe the very processing performed by the data extracting unit 1021 in accordance with the data extraction definition information 1022.

In detail, based on definition indicating which data item should be read from a character string at which location in the data extraction definition information 1022, the processing is expressed directly as a program.

For example, it is assumed that a code “read(“a”, “b”, “c.d”;” means extraction of a character string enclosed by character strings “a” and “b” from an object character string to a data item c.d. Then, at a part where a definition “FROM:=“<TD>” TO:=“</TD>” DATA=inventory.goodsID” should be given, a code “read(“<TD>”, “</TD>”, “inventory.goodsID”);” is generated.

Further, in the above embodiments, there is no specific limit to a network location of the data extraction definition information generation device 100 that provides an environment for generating the data extraction definition information 1022 and a network location of the environment in which the user interface combining device 10 operates. In other words, both may be implemented in the same device connected to a network. Or, the data extraction definition information generation device 100 that provides the environment for generating the data extraction definition information 1022 and the user interface combining device 10 may be positioned at separate locations on a network, and the data extraction definition information 1022 may be sent to the user interface combining device 10 through the network. In the latter case of using separate locations on a network, it is possible to provide an environment in which the data extraction definition information 1022 is managed remotely.

In an environment in which information required for business is distributed among a plurality of WWW servers, a combined user interface environment can provide an information accessing environment that is convenient for a user.

Each of the above embodiments of the present invention provides a developing environment for realizing such a combined user interface environment, improves development efficiency, and reduces the developer's burden. According to each of the above embodiments, it is possible to integrate local area information systems of a business company that manages a plurality of subsidiary companies and branch offices. Further, it is possible to provide a developing environment suitable for developing, for example, an asset information listing system that provides integration of bank account query systems of a plurality of WWW servers.

As described with respect to the first embodiment, although each embodiment has been described taking an example of an HTML source or sources or a JSP source, the present invention is not limited to these. The present invention can be applied to structure that enables extraction of predetermined data.

What is claimed is:

1. A data extraction definition information generation device that generates data extraction definition information for providing said data extraction definition information to a user interface combining device that provides a combined user interface to a client, with said combined user interface being generated, in accordance with said data extraction definition information, from a plurality of user interfaces provided by servers, comprising:
a marked-up page generation means that generates a marked-up page by giving predetermined character strings (hereinafter, referred to as marks) for extracting data items required for constructing said combined user interface to said user interfaces provided by said servers; and
a data extraction definition information generation means that analyzes the marked-up page generated by said marked-up page generation means and generates said data extraction definition information.

2. A data extraction definition information generation device according to claim 1, wherein:
said data extraction definition information generation device further comprises an input means that receives input of marks to be given to said user interfaces; and
said marked-up page generation means generates said marked-up page by giving the marks received by said input means to said user interfaces.

3. A data extraction definition information generation device according to claim 1, wherein:
said marked-up page generation means determines locations to which said marks are given and kinds of said marks according to prescribed features in said user interfaces, and generates said marked-up page by giving the determined kinds of marks to the determined locations.

4. A data extraction definition information generation device according to claim 1, wherein:
said marked-page generation means obtains a plurality of user interfaces provided by said servers, compares said plurality of user interfaces with one another to specify locations of differences and common locations, and generates said marked-up page by giving said marks to locations before and after said locations of differences.

5. A user interface combining system that is connected to a client and servers, generates a combined user interface from a plurality of user interfaces provided by said servers, and provides the generated combined user interface to said client, wherein:
said user interface combining system comprises a user interface combining device and a data extraction definition information generation device according to one of claims 1-4; and
said user interface combining device comprises:
a user interface requesting means that requests said servers to provide said user interfaces, in accordance with a user interface request sent from said client;
a data extraction means that extracts data relating to data items required for constructing said combined user interface from said plurality of user interfaces transferred from said servers;
a combined user interface generation means that generates the combined user interface using the extracted data; and
a sending means that sends the generated combined user interface to said client.

6. A method of generating data extraction definition information used when a combined user interface is generated from a plurality of user interfaces provided by servers and the generated combined user interface is sent to a client, comprising:
a marked-up page generation step, in which a marked up page is generated by giving predetermined character strings (hereinafter, referred to as marks) for extracting data items required for constructing the combined user interface, to said plurality of user interfaces provided by said servers; and
a data extraction definition information generation step, in which the generated marked-up page is analyzed and said data extraction definition information is generated.

7. A method of generating data extraction definition information according to claim 6, wherein:
in said marked-up page generation step, said marks are given to the user interfaces according to input from a user.

8. A method of generating data extraction definition information according to claim 6, wherein:
in said marked-up page generation step, locations to which said marks are given and kinds of said marks are determined according to prescribed features in said user interfaces, and said marks are given to said user interfaces.

9. A method of generating data extraction definition information according to claim 6, wherein:
in said marked-up page generation step, a plurality of user interfaces provided by said servers are obtained, and the obtained user interfaces are compared with one another to specify locations of differences and common locations, and said marks are given to locations before and after said locations of differences of the user interfaces.

10. A program for generating data extraction definition information for providing said data extraction definition information to a user interface combining device that provides a combined user interface to a client, with said combined user interface being generated, in accordance with said data extraction definition information, from a plurality of user interfaces provided by servers, by making a computer functions as:
a marked-up page generation means that generates a marked-up page by giving predetermined character strings (hereinafter, referred to as marks) for extracting data items required for constructing said combined user interface to said user interfaces provided by said servers; and
a data extraction definition information generation means that analyzes the marked-up page generated by said marked-up page generation means and generates said data extraction definition information.
